(19) United States
(12) Patent Application Publication
(10) Pub. No.: US 2008/0124624 A1
(43) Pub. Date: May 29, 2008

(54) Battery casing

(76) Inventor: Ching-Chun Lin, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/589,231

(22) Filed: Oct. 30, 2006

(51) Int. Cl. H01M 2/00

(52) U.S. Cl. 429/163

(57) ABSTRACT

A battery casing includes a plastic frame having a top receiving section and a bottom receiving section, a metal first plate and a metal second plate respectively assembled on the top receiving section and the bottom receiving section. A plurality of first assembling grooves is defined in a rim of the top receiving section, and a plurality of second assembling grooves is defined in a rim of the bottom receiving section. A plurality of first assembling arms extends from a rim of the first plate for being embedded in the first assembling grooves by ultrasonic. A plurality of second assembling arms extends from a rim of the second plate for being embedded in the second assembling grooves by ultrasonic. The first assembling arms offset with respect to the second assembling arms. Therefore the battery casing has decreased height to meet tendency of small profile and facilitates repairing simultaneously.

### BACKGROUND OF THE INVENTION

1. Field of the Invention

The present invention relates to a battery casing, and particularly to a battery casing which is adapted for multimedia electronic products, such as digital cameras, mobile phones and personal digital assistants, and which has a low profile for meeting miniature tendency of electronic products.

2. Related Art

In order to cater to various industries and various types of products, a battery for multimedia electronic products, such as digital cameras, mobile phones and personal digital assistants, is generally received within a battery casing and couples with an electrical connector. The electrical connector mates with a mating connector equipped on a multimedia electronic product for supplying power.

A conventional battery casing comprises two plastic housings which are attached to each other, and then, are assembled together by ultrasonic. In recent years, there is a steady trend toward decreasing physical sizes for multimedia electronic products. Obviously, plastic shaping process constrains decrease of the profile, and therefore can not address this need.

Designers develops a battery casing consisting of a plastic frame and metal plates. During manufacturing, an upper metal plate and a lower metal plate are assembled to a plastic frame, and then are planted integrally to the frame by ultrasonic. The metals plates enhance strength of the plastic frame and improve other functions, and accordingly, the battery casing is able to become thinner without decreasing strength. However, the manufacturing process takes more time, and even reduces capacity.

Another design of a battery casing is brought forth. The battery casing defines assembling holes on opposite sides of a plastic frame. A latch extends from a rim of an upper metal plate, and defines a locking hole therein. A Locking post is formed on a lower metal plate for corresponding to the latch. A locking peg is formed on the locking post for anchoring the locking hole. The latch further defines a guiding slit communicating with the locking hole for guiding the locking peg. During assembly, the locking peg extends through the guiding slit, and finally, is snapped in the locking hole. The overall height of the battery casing cannot be reduced due to the guiding slit. Additionally, the locking peg locks with the locking hole only by means of ratchets, and correspondingly, cannot be detached for repairing.

### SUMMARY OF THE INVENTION

Accordingly, an object of the present invention is to provide a battery casing which has improved and simplified structure so as to decrease the overall height, thereby meeting a trend of miniature, and to facilitate repairing.

To achieve the objects, the battery casing of the present invention comprises a plastic frame, a metal first plate and a metal second plate. The frame includes a top receiving section and a bottom receiving section. A plurality of first assembling grooves is defined in a rim of the top receiving section, and a plurality of second assembling grooves is defined in a rim of the bottom receiving section. A plurality of first assembling arms extends from a rim of the first plate for being embedded in the first assembling grooves by ultrasonic. A plurality of second assembling arms extends from a rim of the second plate for being embedded in the second assembling grooves by ultrasonic. The first assembling arms offset from the second assembling arms.

### BRIEF DESCRIPTION OF THE DRAWINGS

FIG. 1 is an exploded view of a battery casing according to the present invention.

FIG. 2 is a partially assembled view of the battery casing of FIG. 1, wherein a second plate and a contact pad are respectively assembled on a frame thereof.

FIG. 3 is a partially assembled view of the battery casing of FIG. 1, wherein only a first plate is separated from the frame.

FIG. 4 is an assembled view of the battery casing of FIG. 1.

FIG. 5 is a top view of the assembled battery casing of the present invention.

FIGS. 6, 7 and 8 are cross-sectional views respectively taken along the line 6-6, the line 7-7 and the line 8-8 in FIG. 5.

### DESCRIPTION OF THE PREFERRED EMBODIMENTS

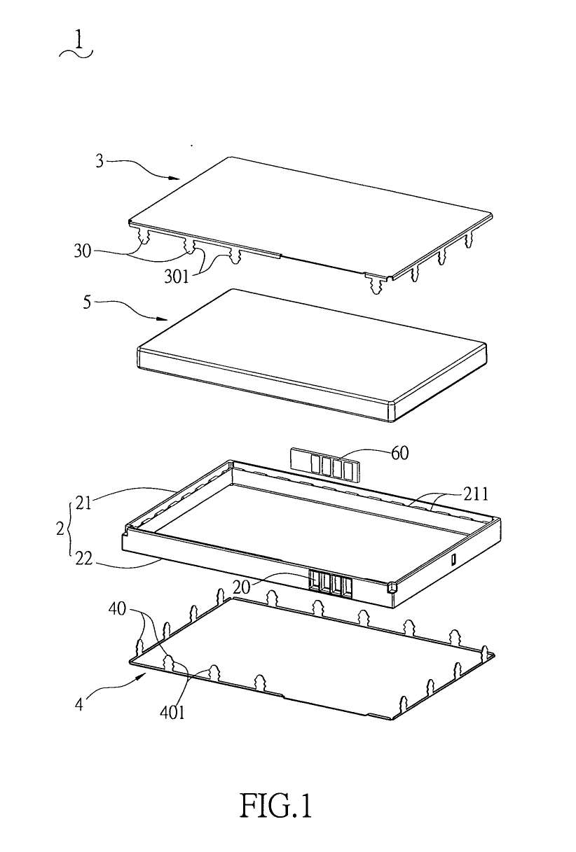

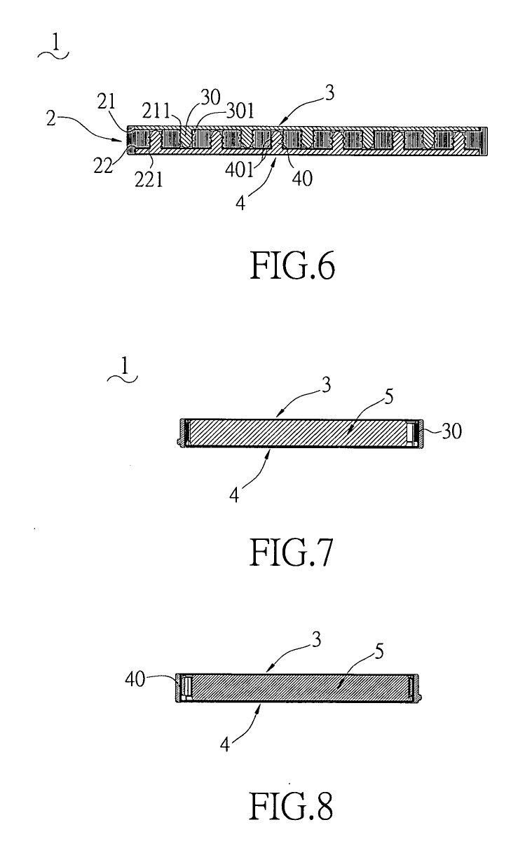

With reference to FIG. 1, a battery casing 1 in accordance with the present invention comprises a plastic frame 2, a metal first plate 3 and a metal second plate 4. The frame 2 receives a battery 5 therein and includes a top receiving section 21 and a bottom receiving section 22. At least a connector slot 20 is defined in the frame 2 for receiving a conductive contact pad 60. A plurality of first assembling grooves 211 is defined in an inner rim of the top receiving section 21, and a plurality of second assembling grooves 221 is defined in an inner rim of the bottom receiving section 22. Further referring to FIG. 6, the first assembling grooves 211 offset with respect to the second assembling grooves 221.

The first plate 3 and the second plate 4 are respectively mounted on the top receiving section 21 and the bottom receiving section 22. A plurality of first assembling arms 30 extends unitarily and downwardly from an outer rim of the first plate 3 for being assembled in the first assembling grooves 211. The first assembling arms 30 correspond to the first assembling grooves 211 in place. A plurality of second assembling arms 40 extends unitarily and upwardly from an outer rim of the second plate 4 for being assembled in the second assembling grooves 221. The second assembling arms 40 correspond to the second assembling grooves 221 in place. The first assembling arms 30 offset relative to the second assembling arms 40. Each first assembling arm 30 forms first interferential portions, for example first barbs 301, on opposite sides thereof for interferentially fitting to inner walls of the first assembling grooves 211. Each second assembling arm 40 forms second interferential portions, for example second barbs 401, on opposite sides thereof for interferentially fitting to inner walls of the second assembling grooves 221. Thus, the first plate 3 and the second plate 4 are firmly assembled on the top receiving section 21 and the bottom receiving section 22, respectively. Length of the first assembling arms 30 and the second assembling arms 40 are equal to or less than length of the first assembling grooves 211 and the second assembling grooves 221.

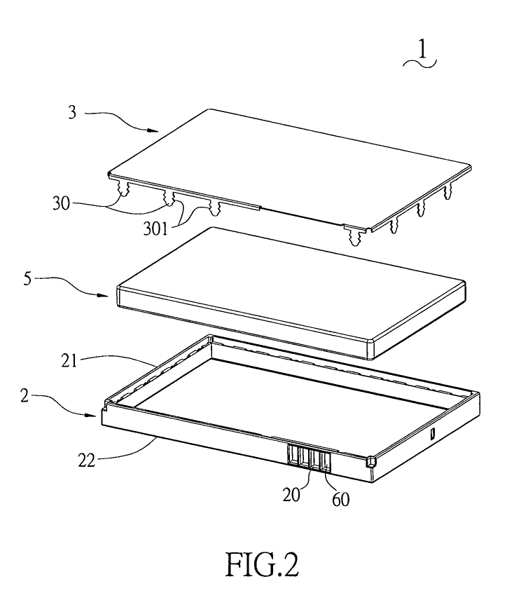

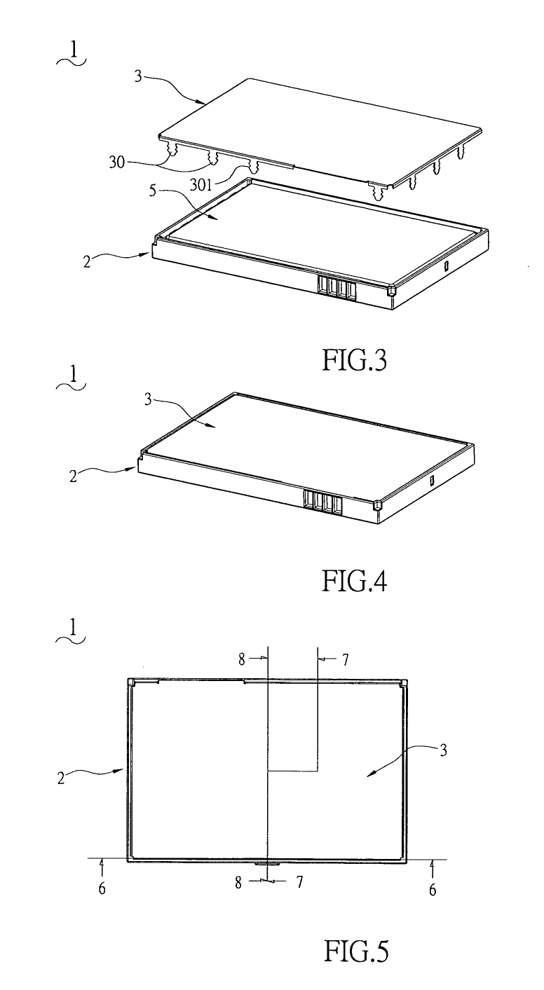

In assembly, referring to FIGS. 2 to 4, the second assembling arms 40 of the second plate 4 are embedded into the bottom receiving section 22 by ultrasonic. The contact pad 60 is accommodated in the slot 20, as shown in FIG. 2. The battery 5 is received in the frame 2, as shown in FIG. 3. Finally, referring to FIG. 4, the first assembling arms 30 of the first plate 3 are embedded into the top receiving section 21 by ultrasonic. Further referring to FIGS. 6 to 8, the first assembling arms 30 and the second assembling arms 40 are respectively assembled on the first assembling grooves 211 and the second assembling grooves 221. Therefore, the first plate 3 and the second plate 4 are securely retained to the top receiving section 21 and the bottom receiving section 22 of the frame 2, respectively. As clearly shown in FIG. 6, the first assembling arms 30 offset relative to the second assembling arms 40.

In the instant invention, the first plate 3 and the second plate 4 are respectively fastened to the top receiving section 21 and the bottom receiving section 22 of the frame 2 conveniently and quickly. Moreover, thanks to the offsetting relation of the first assembling arms 30 with respect to the second assembling arms 40, the overall height of the battery casing 1 is decreased.

It is understood that the invention may be embodied in other forms without departing from the spirit thereof. Thus, the present examples and embodiments are to be considered in all respects as illustrative and not restrictive, and the invention is not to be limited to the details given herein.

1. A battery casing comprising:
a plastic frame defining a connector slot, and including a top receiving section and a bottom receiving section, a plurality of first assembling grooves being defined in a rim of the top receiving section, and a plurality of second assembling grooves being defined in a rim of the bottom receiving section; and
a metal first plate and a metal second plate, a plurality of first assembling arms extending from a rim of the first plate for being embedded in the first assembling grooves by ultrasonic, and a plurality of second assembling arms extending from a rim of the second plate for being embedded in the second assembling grooves by ultrasonic, the first assembling arms offsetting with respect to the second assembling arms.

2. The battery casing as claimed in claim 1, wherein the first assembling arms extend unitarily from a rim of the first plate, each first assembling arm forming first interferential portions thereon for interferentially fitting to inner walls of the first assembling grooves, and wherein the second assembling arms extend unitarily from a rim of the second plate, each second assembling arm forming second interferential portions thereon for interferentially fitting to inner walls of the second assembling grooves.

3. The battery casing as claimed in claim 2, wherein the first interferential portions are first barbs, and wherein the second interferential portions are second barbs.

4. The battery casing as claimed in claim 1, wherein the first assembling arms correspond to the first assembling grooves in place, and wherein the second assembling arms correspond to the second assembling grooves in place.

5. A battery casing comprising:
a plastic frame defining a connector slot, and including a top receiving section and a bottom receiving section, a plurality of first assembling grooves being defined in a rim of the top receiving section, and a plurality of second assembling grooves being defined in a rim of the bottom receiving section; and
a metal first plate and a metal second plate respectively assembled on the top receiving section and the bottom receiving section, a plurality of first assembling arms extending from a rim of the first plate for being assembled in the first assembling grooves, and a plurality of second assembling arms extending from a rim of the second plate for being assembled in the second assembling grooves.

6. The battery casing as claimed in claim 5, wherein the first assembling arms extend unitarily from a rim of the first plate, each first assembling arm forming first interferential portions thereon for interferentially fitting to inner walls of the first assembling grooves, and wherein the second assembling arms extend unitarily from a rim of the second plate, each second assembling arm forming second interferential portions thereon for interferentially fitting to inner walls of the second assembling grooves.

7. The battery casing as claimed in claim 6, wherein the first interferential portions are first barbs, and wherein the second interferential portions are second barbs.

8. The battery casing as claimed in claim 5, wherein length of the first assembling arms and the second assembling arms are equal to or less than length of the first assembling grooves and the second assembling grooves.

9. The battery casing as claimed in claim 5, wherein the first assembling grooves correspond to the first assembling arms in place, and wherein the second assembling grooves correspond to the second assembling arms in place.
